(19) United States
(12) Patent Application Publication
(10) Pub. No.: US 2005/0149338 A1
(43) Pub. Date: Jul. 7, 2005

(54) Ultrasonic speaker and audio signal playback control method for ultrasonic speaker

(76) Inventor: Yoshiki Fukui, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/929,118

(22) Filed: Aug. 27, 2004

(30) Foreign Application Priority Data
Sep. 22, 2003 (JP) 2003-330234

(51) Int. Cl. G10L 11/00

(52) U.S. Cl. 704/278

(57) ABSTRACT

An ultrasonic speaker that outputs a playback signal, which is an audio signal in an audible frequency band, including: an audible frequency oscillation source to generate a signal wave in an audible frequency band; a carrier wave oscillation source to generate and output a carrier wave; a modulator to modulate a carrier wave with the signal wave; and an ultrasonic transducer, driven by a modulation signal outputted from the modulator, to transform the modulation signal to a sound wave at a finite amplitude level to be radiated into a medium, is provided with a psychoacoustic analysis processing portion to remove human-imperceptible signal components contained in a signal wave outputted from the audible frequency oscillation source, and output the signal wave, from which human-imperceptible signal components have been removed, to the modulator.

### FIELD OF THE INVENTION

The present invention relates to an ultrasonic speaker and an audio signal playback control method for an ultrasonic speaker for playing back an audio signal in an audible frequency band using non-linearity of a medium (air) with respect to an ultrasound.

### BACKGROUND OF THE INVENTION

Conventionally, an ultrasonic speaker exploiting non-linearity of air (medium) with respect to an ultrasound is known to have the ability to play back a signal in an audible frequency band having a far sharper directivity than a normal speaker The ultrasonic speaker modulates a carrier wave in an ultrasonic frequency band with a signal wave in an audible frequency band from a signal source, and amplifies the carrier wave in a power amplifier or the like, after which it transforms the carrier wave to a sound wave at a finite amplitude level and radiates the resulting sound wave into a medium (into air) from an ultrasonic transducer, thereby playing back an original audio signal in an audible frequency band by the non-linearity effect of the medium (air).

The mechanism by which a signal in an audible frequency band is generated in this instance is a signal is generated by a difference tone among a plurality of different frequency signals in an ultrasonic band generated as a result of the modulation. Distortion components that adversely affect the playback corresponding to an original input signal are generated more as the configuration of the plurality of different frequency signals becomes more complex. This results in reduced demodulation efficiency (a playback volume is lowered). For example, when comparing a signal of a monotonic waveform (for example, a sinusoidal signal) and an arbitrary acoustic signal (for example, a musical signal) of a complex waveform as input signals, a playback volume of the latter is lower.

### SUMMARY OF THE INVENTION

The invention was devised in view of the foregoing, and therefore an object is to provide an ultrasonic speaker and an audio signal playback control method for an ultrasonic speaker with improved demodulation efficiency of an audio signal in an audible frequency band.

An object of the present invention is to provide an audio signal playback control method for an ultrasonic speaker that plays back an audio signal in an audible frequency band by modulating a carrier wave with a signal wave outputted from a signal source generating a signal wave in an audible frequency band and by driving an ultrasonic transducer with a resulting modulation signal. Human-imperceptible signal components contained in the signal wave are removed in advance. In this manner, the carrier wave is modulated with the signal wave, from which the human-imperceptible signal components have been removed, and the ultrasonic transducer is driven by a resulting modulation signal.

An aspect of the present invention is to provide an ultrasonic speaker that outputs a playback signal, which is an audio signal in an audible frequency band, including: a signal source to generate a signal wave in an audible frequency band; carrier wave supplying means for generating and outputting a carrier wave; modulating means for modulating the carrier wave with the signal wave; and an ultrasonic transducer, which is driven by a modulation signal outputted from the modulating means, to transform the modulation signal to a sound wave at a finite amplitude level to be radiated into a medium. Also provided is unwanted signal component removing means for removing human-imperceptible signal components contained in a signal wave outputted from the signal source, and outputting the signal wave, from which the human-imperceptible signal components have been removed, to the modulator.

In an audio signal playback control method for an ultrasonic speaker that plays back an audio signal in an audible frequency band by modulating a carrier wave with a signal wave outputted from a signal source generating a signal wave in an audible frequency band and by driving an ultrasonic transducer with a resulting modulation signal, the method is arranged in such a manner that human-imperceptible signal components contained in the signal wave are removed in advance, so that the carrier wave is modulated with the signal wave, from which the human-imperceptible signal components have been removed, and the ultrasonic transducer is driven by a resulting modulation signal. Hence, the complexity in a complex, arbitrary acoustic signal can be reduced, and there can be achieved an advantage that demodulation efficiency of an audio signal in an audible frequency band to be played back can be improved.

Also provided by the present invention is an ultrasonic speaker that outputs a playback signal, which is an audio signal in an audible frequency band, including: a signal source to generate a signal wave in an audible frequency band; carrier wave supplying means for generating and outputting a carrier wave; modulating means for modulating the carrier wave with the signal wave; and an ultrasonic transducer, driven by a modulation signal outputted from the modulating means, to transform the modulation signal to a sound wave at a finite amplitude level to be radiated into a medium, is provided with unwanted signal component removing means for removing human-imperceptible signal components contained in a signal wave outputted from the signal source, and outputting the signal wave, from which the human-imperceptible signal components have been removed, to the modulator. The complexity in a complex, arbitrary acoustic signal can be thereby reduced, which can in turn improve demodulation efficiency of an audio signal in an audible frequency band to be played back.

### BRIEF DESCRIPTION OF THE DRAWINGS

FIG. 1 is a block diagram showing the configuration of an ultrasonic speaker according to one embodiment of the invention;

FIG. 2 is an explanatory view to conceptually describe the content of absolute threshold hearing processing performed in a psychoacoustic analysis processing portion in the ultrasonic speaker according to one embodiment of the invention shown in FIG. 1;

FIG. 3 is an explanatory view to conceptually describe the content of masking effect processing performed in the psychoacoustic analysis processing portion in the ultrasonic speaker according to one embodiment of the invention shown in FIG. 1;

FIG. 4 is a view showing a concrete configuration of an ultrasonic transducer in the ultrasonic speaker according to one embodiment of the invention shown in FIG. 1;

FIG. 5 is a characteristic view showing a frequency characteristic of the ultrasonic transducer shown in FIG. 4;

FIG. 6 is an explanatory view to describe the advantages of the invention that demodulation efficiency of a playback sound in an audible frequency band is improved;

FIG. 7 is a view showing a frequency distribution of a modulation signal when a carrier wave is modulated with a monotonic signal wave in an audible frequency band; and

FIG. 8 is a view showing a frequency distribution of a modulation signal when a carrier wave is modulated with a complex signal wave in an audible frequency band.

### DETAILED DESCRIPTION OF THE PREFERRED EMBODIMENTS

One embodiment of the invention will now be described in detail with reference to the drawings. Prior to the description of the embodiment of the invention, the mechanism by which a signal in an audible frequency band is generated will be described briefly.

In an ultrasonic speaker, processing to modulate a carrier signal (carrier wave) in an ultrasonic frequency band with an original signal (signal wave) in an audible frequency band is performed. A DSB-WC (Double Side Band With Carrier AM) modulation will be described as a modulation system by way of example. For non-linear propagation, more than one model described below will be formed due to the occurrence of harmonic components; however, a description will be given using a single model because, basically, there is no correlation among models.

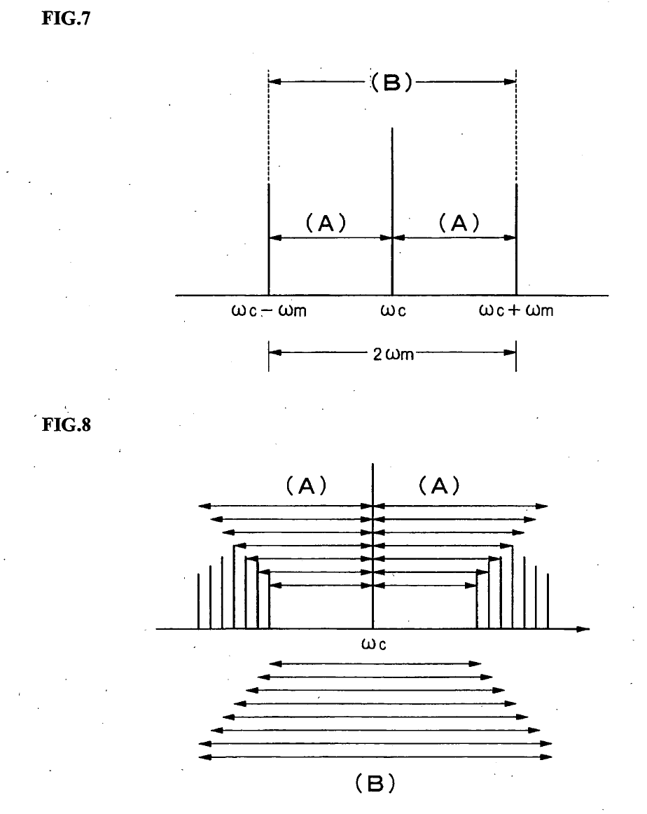

A signal P(t) obtained by modulating a carrier signal (cos(ω_{c}t)) in an ultrasonic band with an audible signal (cos(ωₘt)) is expressed by Equation (1) set forth below, and FIG. 7 shows the frequency distribution in this instance.

Arrows (A) and an arrow (B) in the drawing show a relation that becomes a factor responsible for the generation of a tone difference. The arrows (A) generate an original audible signal ωₘ, and the arrow (B) generates double (2ωₘ) the original audible signal ωₘ.
p(t)={1+m cos(ωₘt)} cos(ω_{c}t)(ωₘ<<ω_{c}) (1)
where m is a degree of modulation.

When the audible signal (cos(ωₘt)) portion is modulated in the same manner with an arbitrary signal E(t) in an audible range, Equation (2) set forth below is achieved, and FIG. 8 shows the frequency distribution in this instance. In the case of an arbitrary signal, the frequency distribution of signal components becomes complex as is shown in FIG. 8, and so does the configuration of a tone difference.

A group of arrows indicated by arrows (B) in the drawing becomes a factor responsible for the generation of distortion, which, as a result, lowers a volume of a tone difference (playback of the original signal) generated from the configuration indicated by arrows (A).
p(t)={1+m E(t)} cos(ω_{c}t)(ωₘ<<ω_{c}) (2)
where m is a degree of modulation.

The frequency distribution of signal components shown in FIG. 8 becomes less complex as a signal, namely an arbitrary signal E(t) in an audible range, which is the original signal, is simpler.

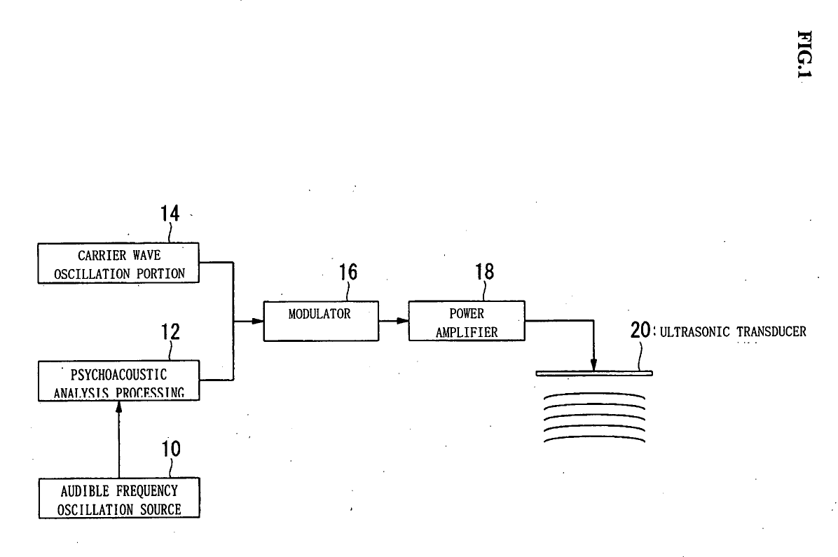

Next, FIG. 1 shows the configuration of the ultrasonic speaker according to one embodiment of the invention. Referring to the drawing, the ultrasonic speaker according to the embodiment of the invention includes an audible frequency oscillation source 10, a psychoacoustic analysis processing portion 12, a carrier wave oscillation source 14, a modulator 16, a power amplifier 18, and an ultrasonic transducer 20.

The audible frequency oscillation source 10 is furnished with a function of generating a signal wave (acoustic signal) in an audible frequency band.

The psychoacoustic analysis processing portion 12 performs processing to remove human-imperceptible signal components in advance on a signal wave (acoustic signal) in an audible frequency band on the basis of psychoacoustic analysis.

The processing (psychoacoustic analysis processing), performed in the psychoacoustic analysis processing portion 12 on an arbitrary acoustic signal of a complex waveform, to reduce the complexity of a waveform in advance will now be described.

As a compression technique for an acoustic signal, there have been techniques, such as ISO-MPEG Audio Layer3 (MP3). These techniques adopt a method of eliminating human-imperceptible signal components through psychoacoustic analysis, as one means for reducing acoustic signal data.

As a concrete technique of eliminating human-imperceptible signal components, absolute threshold hearing processing and masking effect processing methods are known.

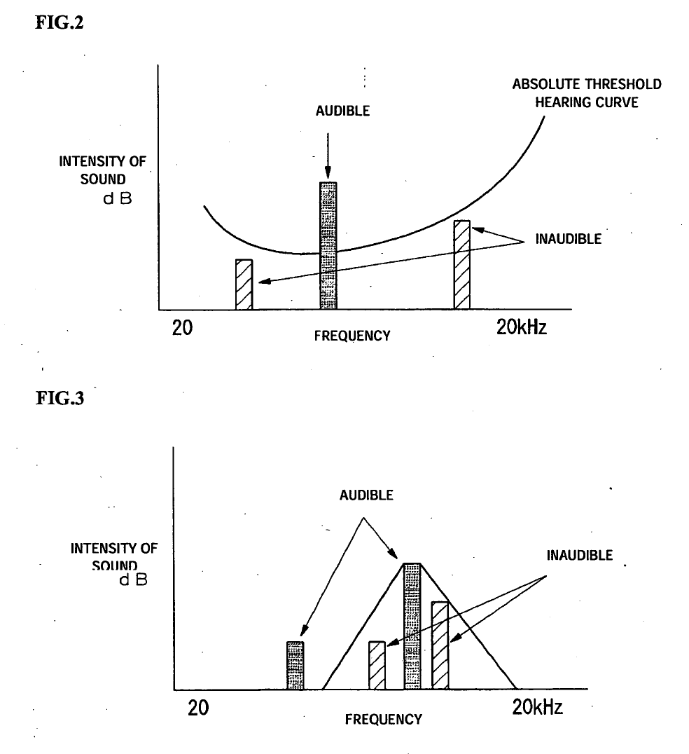

The absolute threshold hearing processing method eliminates human-imperceptible signal components by exploiting the fact that the intensity of sound a human starts to hear differs with frequency bands. As is shown in FIG. 2, because a range on or below the absolute threshold hearing curve is inaudible, it is possible to eliminate this portion.

Also, the masking effect processing method eliminates human-imperceptible signal components by exploiting the fact that faint sounds at substantially the same frequency are present immediately before and immediately after a loud sound, or by exploiting the fact that faint sounds at substantially the same frequency and buried in a loud sound are inaudible.

FIG. 3 shows an example of frequency masking, and because sounds at substantially the same frequency in a specific range about an intense sound are inaudible, it is possible to eliminate this portion. Likewise, when the abscissa of FIG. 3 is used for the time axis, because faint sounds at substantially the same frequency are present immediately before and immediately after an intense sound are inaudible, this portion can be eliminated as well.

The contents of the psychoacoustic analysis processing use related arts, and are therefore outside of the scope of the invention. Related arts include, the ISO-MPEG Audio Layer3 standard, a technique disclosed for an audio signal encoding apparatus in JP-A-2002-311997, a technique disclosed for a speech encoding apparatus and a psychoacoustic analysis method used in JP-A-2002-23799.

By performing the absolute threshold hearing processing method and the masking effect processing method as described above in the psychoacoustic analysis processing portion 12, the complexity of an arbitrary acoustic signal of a complex waveform is reduced, which can in turn improve demodulation efficiency of an audio signal in an audible frequency band to be played back.

The carrier wave oscillation source 14 generates a carrier wave in an ultrasonic band.

The modulator 16 amplitude-modulates a carrier wave outputted from the carrier wave oscillation source 14 with a signal wave outputted from the psychoacbustic analysis processing portion 12.

The ultrasonic transducer 20 is driven by a modulation signal outputted from the modulator 16, and transforms the modulation signal to a sound wave at a finite amplitude level to be radiated into a medium (into air).

When an ultrasonic carrier (carrier wave) at a high sound pressure is radiated into air subsequent to amplitude-modulation with an audible sound signal (signal wave) as described above, the speed of sound is high where the sound pressure is high and the speed of sound is low where the sound pressure is low due to the non-linearity of air. This gives rise to deformation in the waveform. Hence, deformation is accumulated in the waveform while a sound wave propagates through air, and carrier components are attenuated gradually, which allows self-demodulation of audible sound components used in modulation (parametric array effect). An audible sound that has been self-demodulated by being carried on an ultrasound has sharp directivity, and it is thus possible to form an ultrasonic speaker.

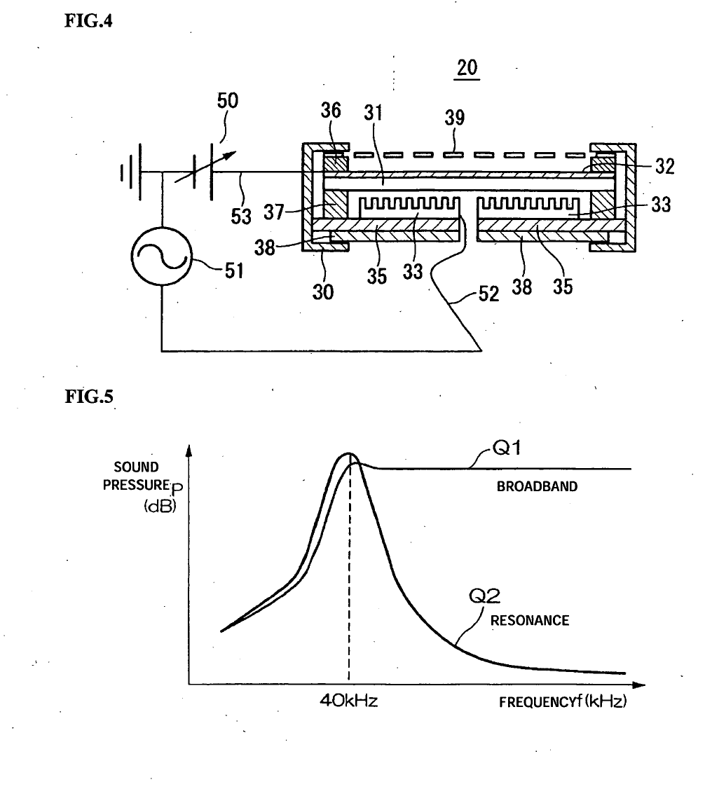

The ultrasonic transducer 20 in this embodiment of the invention is able to oscillate an acoustic signal in a broadband. FIG. 4 shows a configuration of the ultrasonic transducer 6. Referring to the drawing, the electrostatic ultrasonic transducer 20 uses, as an oscillator, a dielectric material 31 (insulator), such as PET (polyethylene terephthalate resin), having a thickness in the range of 3 to 10 μm. An upper electrode 32 in the form of metal foil of aluminum or the like is formed integrally with the dielectric material 31 on its top surface by a method such as vapor deposition, and a lower electrode 33 made of brass is provided to come into contact with the bottom surface of the dielectric material 31. The lower electrode 33 is connected to a lead 52 and is also fixed to a base plate 35, made of bakelite or the like.

The upper electrode 32 is also connected to a lead 53. The lead 53 is connected to a dc bias power supply 50. A dc bias voltage in the range of 50 to 150 V for attracting the upper electrode is constantly applied to the upper electrode 32 from the dc bias power supply 50, and the upper electrode 32 is thereby attracted toward the lower electrode 33. Numeral 51 denotes an ac signal source (an output from the power amplifier 5 in this embodiment). The dielectric material 31, the upper electrode 32, and the base plate 35 are caulked with a case 30 together with metal rings 36, 37, and 38, and a mesh 39.

A plurality of minute grooves of irregular shapes on the order of dozens to hundreds μm are formed in the surface of the lower electrode 33 on the dielectric material 31 side. Because these minute grooves are defined by spaces between the lower electrode 33 and the dielectric material 31, the distribution of an electrostatic capacitance between the upper electrode 32 and the lower electrode 33 varies minutely. These random minute grooves are formed by roughening the surface of the lower electrode 33 manually with the use of a file.

A myriad of capacitors having different sizes and depths of spaces are formed in an electrostatic ultrasonic transducer in this manner, and the frequency characteristic of the ultrasonic transducer 20 covers a broadband as is indicted by a curve Q1 of FIG. 5.

For the ultrasonic transducer 20 configured as described above, an ac signal voltage (an output from the power amplifier 18) is applied across the upper electrode 32 and the lower electrode 33 while a dc bias voltage is kept applied to the upper electrode 32. Incidentally, as is indicated by the curve Q2 of FIG. 5, for a resonance ultrasonic transducer, the center frequency (a resonance frequency of piezoelectric ceramics) is, for example, 40 kHz, and at a frequency ±5 kHz from the center frequency at which the sound pressure is a maximum, the frequency characteristic is −30 dB from the maximum sound pressure. In contrast, for the ultrasonic transducer of the broadband oscillation type configured as described above, the frequency characteristic is flat from 40 kHz to the vicinity of 100 kHz, and is about ±6 dB from the maximum sound pressure at 100 kHz.

When an ultrasound propagates through a medium (air), the outreach becomes shorter as the frequency of a sound wave becomes higher. Because the ultrasonic transducer 6 has a broadband frequency characteristic, by driving the ultrasonic transducer 6 while changing the frequencies of a carrier wave used to carry a signal wave, it is possible to control a range of the outreach of a playback sound without changing a sound pressure level to be self-modulated, that is, a playback sound pressure.

For the ultrasonic speaker of the invention, the ultrasonic transducer 20 is not necessarily a broadband oscillation ultrasonic transducer, and it may be a narrowband, that is, resonance ultrasonic transducer.

Operations of the ultrasonic speaker of this embodiment configured as described above will now be described. A signal wave (acoustic signal) in an audible frequency band, outputted from the audible frequency oscillation source 10 serving as a signal source, is inputted into the psychoacoustic analysis processing portion 12. The psychoacoustic analysis processing portion 12 performs processing to remove human-imperceptible signal components in advance on the signal wave (acoustic signal) in the audible frequency band on the basis of the psychoacoustic analysis, and thereby outputs the signal wave, from which human-imperceptible signal components have been removed, to the modulator 16.

The carrier wave oscillation source 14 generates a carrier wave in an ultrasonic frequency band, and outputs the same to the modulator 16.

The modulator 16 amplitude-modulates the carrier wave in the ultrasonic frequency band inputted from the carrier wave oscillation source 14 with the signal wave (acoustic signal in the audible frequency band) inputted from the psychoacoustic analysis processing portion 12, from which the human-imperceptible signal components have been removed, and outputs the resulting modulation signal to the power amplifier 18. The modulation signal amplified in the power amplifier 18 is applied across the upper electrode 32 and the lower electrode 33 of the ultrasonic transducer 20. The modulation signal is transformed to a sound wave (acoustic signal) at the finite amplitude level, and is then radiated into a medium (into air).

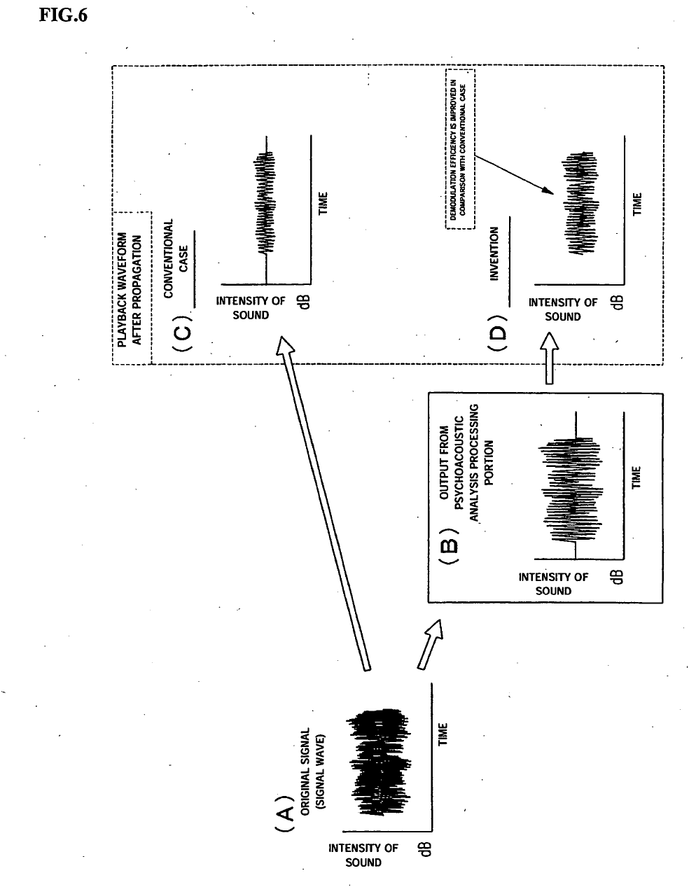

FIG. 6 shows playback waveforms of an original signal obtained by transforming a signal wave outputted from the audible frequency oscillation source 10 to an acoustic signal, of an acoustic signal obtained by transforming a signal wave, from which human-imperceptible signal components have been removed in the psychoacoustic analysis processing portion 12, to an acoustic signal, and of an acoustic signal after it is propagated through a medium (air) from the ultrasonic transducer 20. Referring to the drawing, as to the original signal (FIG. 6(A)) obtained by transforming a signal wave outputted from the audible frequency oscillation source 10 to an acoustic signal, in a conventional ultrasonic speaker, because human-imperceptible, unwanted signal components are not removed from a signal wave before it modulates a carrier wave, these signal components result in noise components, and as is shown in FIG. 6(C), a sound pressure level of a playback signal is lowered.

In contrast, in the invention as has been described, because of the processing to remove human-imperceptible signal components in advance is performed on a signal wave outputted from the audible frequency oscillation source 10, in the psychoacoustic analysis processing portion 12 on the basis of psychoacoustic analysis, it is possible to obtain a signal wave from which human-imperceptible signal components have been removed. When the signal wave is transformed to an acoustic signal, the complexity of the waveform of this acoustic signal is reduced with respect to the original signal as is shown in FIG. 6(B), and as is shown in FIG. 6(D), for the playback waveform of an audio signal in an audible frequency band to be played back, a larger sound pressure level can be taken. That is, demodulation efficiency can be improved.

As has been described, according to the ultrasonic speaker of this embodiment, human-imperceptible signal components contained in a signal wave are removed in advance, then a carrier wave used to carry a signal wave is modulated with the signal wave from which human-imperceptible signal components have been removed, and the ultrasonic transducer is driven by the resulting modulation signal. The complexity of a complex, arbitrary acoustic signal is thus reduced, which can in turn improve demodulation efficiency of an audio signal in an audible frequency band to be played back.

The ultrasonic speaker of the invention can be used as a sound source of a home theater, or alternatively, as a speaker to transmit speech information in a finite spatial region.

1. An audio signal playback control method for an ultrasonic speaker that plays back an audio signal in an audible frequency band comprising:
removing human-imperceptible signal components contained in a signal wave;
modulating a carrier wave with the signal wave outputted from a signal source, said signal source generating the signal wave in an audible frequency band; and
driving an ultrasonic transducer with a resulting modulation signal.

2. An ultrasonic speaker that outputs a playback signal, which is an audio signal in an audible frequency band, comprising:
a signal source to generate a signal wave in an audible frequency band;
carrier wave supplying means for generating and outputting a carrier wave;
modulating means for modulating said carrier wave with said signal wave; an ultrasonic transducer, driven by a modulation signal outputted from said modulating means, to transform the modulation signal to a sound wave at a finite amplitude level to be radiated into a medium; and
unwanted signal component removing means for removing human-imperceptible signal components contained in a signal wave outputted from said signal source, and for outputting said signal wave, from which the human-imperceptible signal components have been removed, to said modulating means.

3. The method according to claim 1, wherein said step of removing human-imperceptible signal components contained in a signal wave comprises removing said human-imperceptible signal components from said signal wave by removing a frequency band below an absolute hearing threshold.

4. The method according to claim 1, wherein said step of removing human-imperceptible signal components contained in a signal wave comprises removing said human-imperceptible signal components from said signal wave by masking sounds at substantially the same frequency immediately before or immediately after an intense sound.

5. The ultrasonic speaker according to claim 2, wherein said unwanted signal component removing means removes said human-imperceptible signal components from said signal wave by removing a frequency band below an absolute hearing threshold.

6. The ultrasonic speaker according to claim 2, wherein said unwanted signal component removing means removes said human-imperceptible signal components from said signal wave by masking sounds at substantially the same frequency immediately before or immediately after an intense sound.
